(19) United States
(12) Patent Application Publication
(10) Pub. No.: US 2011/0097816 A1
(43) Pub. Date: Apr. 28, 2011

(54) METHODS FOR CHANGING DENSITIES OF NON-TARGET PARTICLES OF A SUSPENSION

(76) Inventor: Paul C. Goodwin, City of Shoreline, WA (US)

(21) Appl. No.: 12/911,610

(22) Filed: Oct. 25, 2010

Related U.S. Application Data
(60) Provisional application No. 61/254,290, filed on Oct. 23, 2009.

(51) Int. Cl. G01N 1/28

(52) U.S. Cl. 436/178

(57) ABSTRACT

This disclosure is directed to methods for isolating target materials from non-target materials of a suspension that have a similar density to that of the target material. A suspension suspected of containing a target material is added to a tube and float system. A solution containing molecules that interact specifically with the non-target materials to change the density of the non-target materials in also added. A float is also added to the tube, and the tube, float, and suspension are centrifuged together. The float has a specific gravity that positions the float at approximately the same level as a layer containing the target material when the tube, float and suspension are centrifuged. During centrifugation, the non-target material/molecules complexes are drawn either below the float or above float, leaving the target material between the outer surface of the float and the inner surface of the tube.

### CROSS-REFERENCE TO RELATED APPLICATION

This application claims the benefit of Provisional Application No. 61/254,290, filed Oct. 23, 2009.

### TECHNICAL FIELD

This disclosure relates to capturing and isolating target materials of a suspension.

### BACKGROUND

Suspensions often include particles of interests that are difficult to extract and isolate for analysis because the particles occur with such low frequency. For example, blood is a suspension of various particles that is routinely examined for the presence of abnormal organisms or cells, such as circulating tumor cells (“CTCs”), ova, parasites, microorganisms, and inflammatory cells. CTCs are of particular interest because CTCs are cancer cells that have detached from a primary tumor, circulate in the bloodstream, and may be regarded as seeds for subsequent growth of additional tumors (i.e., metastasis) in different tissues. As a result, detecting, enumerating, and characterizing CTCs may provide valuable information in monitoring and treating cancer patients. Although detecting CTCs may help clinicians and cancer researchers predict a patient's chances of survival and/or monitor a patient's response to cancer therapy, CTC numbers are typically very small and are not easily detected. In particular, typical CTCs are found in frequencies on the order of 1-10 CTCs per milliliter sample of whole blood obtained from patients with a metastatic disease. By contrast, a single milliliter sample of whole blood typically contains a few million white blood cells and a billion red blood cells.

However, isolating and identifying a particular type of low frequency particle of interest can be difficult when the suspension includes other particles having similar shape, size, and density. For example, isolating and identifying CTCs in a blood sample can be difficult because a typical blood sample includes other cells with similar shape, size, and density as the CTCs, such as white blood cells. Practitioners, researchers, and those working with suspensions continue to seek systems and methods for isolating particles of interest from other particles that are not of interest but have a similar shape, size, and density.

### SUMMARY

This disclosure is directed to methods for isolating target materials from non-target materials of a suspension that have a similar density to that of the target material. A suspension suspected of containing a target material is added to a tube. A solution containing molecules that interact specifically with the non-target materials to change the density of the non-target materials in also added to the tube. A float is also added to the tube, and the tube, float, and suspension are centrifuged together, causing the various materials suspended in the suspension to separate into different layers along the axial length of the tube according to their specific gravities. The float has a specific gravity that positions the float at approximately the same level as a layer containing the target material when the tube, float and suspension are centrifuged. During centrifugation, the non-target material/molecules complexes are drawn either below the float or above float, leaving the target material between the outer surface of the float and the inner surface of the tube.

### BRIEF DESCRIPTION OF THE DRAWINGS

FIG. 1 shows an isometric view of an example tube and float system.

FIGS. 2-5 show examples of different types of floats.

FIGS. 6A-6B show example reactions of a ligand/weight complex with a non-target particle and a target particle.

FIG. 7 shows a suspension disposed within a tube and float system and example snap shots of a ligand/weight complex interacting with a non-target particle and a target particle.

FIGS. 8A-8B show snap shots of a region between a float outer surface and a tube inner surface during centrifugation with non-target particle/ligand/weight complex drawn downward.

FIGS. 9A-9B show snap shots of a region between a float outer surface and a tube inner surface during centrifugation with non-target particle/ligand/weight complex drawn upward.

FIGS. 10A-10B show systems for generating a magnetic field that draws non-target particle/ligand/weight complex downward.

FIGS. 11A-11B show example reactions of buoyant molecules with a non-target particle and a target particle.

FIG. 12 shows a snap shot of a region between a float outer surface and a tube inner surface during centrifugation with non-target particle/buoyant molecule complexes drawn upward.

### DETAILED DESCRIPTION

A suspension is a fluid containing particles that are sufficiently large for sedimentation. A typical suspension may contain, in addition to a sought after target material, a wide variety of other materials. Examples of suspensions include paint, urine, anticoagulated whole blood, and other bodily fluids. A target material can be cells, organisms, or particles whose density equilibrates when the suspension is centrifuged. Examples of target materials found in suspensions obtained from living organisms include cancer cells, ova, inflammatory cells, viruses, parasites, and microorganisms, each of which has an associated specific gravity or density. When the suspension is added to a tube and float system and centrifuged, the various materials separate into different layers along the axial length of the tube according to their specific gravities. The float can be selected with a specific gravity to substantially match that of the target material. As a result, after centrifugation, the float is ideally positioned at approximately the same level as a layer containing the target material and expands the axial length of the layer containing the target material so that nearly the entire quantity of target material is positioned between the float outer surface and the inner surface of the tube. However, when the amount of target material is small and other non-target materials having a similar density to that of the target material also fill the region between the outer surface of the float and the inner surface of the tube, isolation and identification of the target material can be problematic. Methods of this disclosure are directed to preventing the non-target materials with a similar specific gravity similar to that of the target material from accumulating in the region between the float outer surface and the inner surface of the tube during centrifugation, making isolation and identification of the target material substantially less problematic.

The detailed description is organized into two subsections as follows: Various tube and float systems for isolating and separating target materials from other materials in a suspension are described below in a first subsection. Methods for separating the non-target materials from target materials using tube and float systems are described in a second subsection.

### Tube and Float Systems

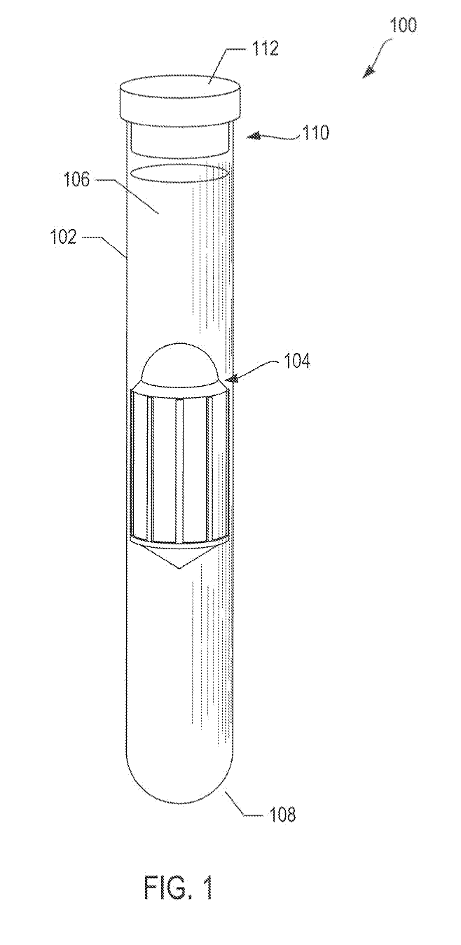

FIG. 1 shows an isometric view of an example tube and float system 100. The system 100 includes a tube 102 and a float 104 suspended within a suspension 106. In the example of FIG. 1, the tube 102 has a circular cross-section, a first closed end 108, and a second open end 110. The open end 110 is sized to receive a stopper or cap 112, but the open end 110 can also be configured with threads (not shown) to receive a threaded stopper or screw cap 112 that can be screwed onto the open end 110. The tube 102 can also be configured with two open ends that are both configured to receive stoppers or caps. As shown in FIG. 1, the tube 102 has a generally cylindrical geometry, but may also be configured with a tapered geometry that widens toward the open end 110. The tube 102 can be composed of a transparent or semitransparent material, such as plastic or another suitable material. Although the tube 102 shown in FIG. 1 has a circular cross-section, in other embodiments, the tube 102 can have an elliptical, a square, a rectangular, an octagonal, or any other suitable cross-sectional shape that substantially extends the length of the tube.

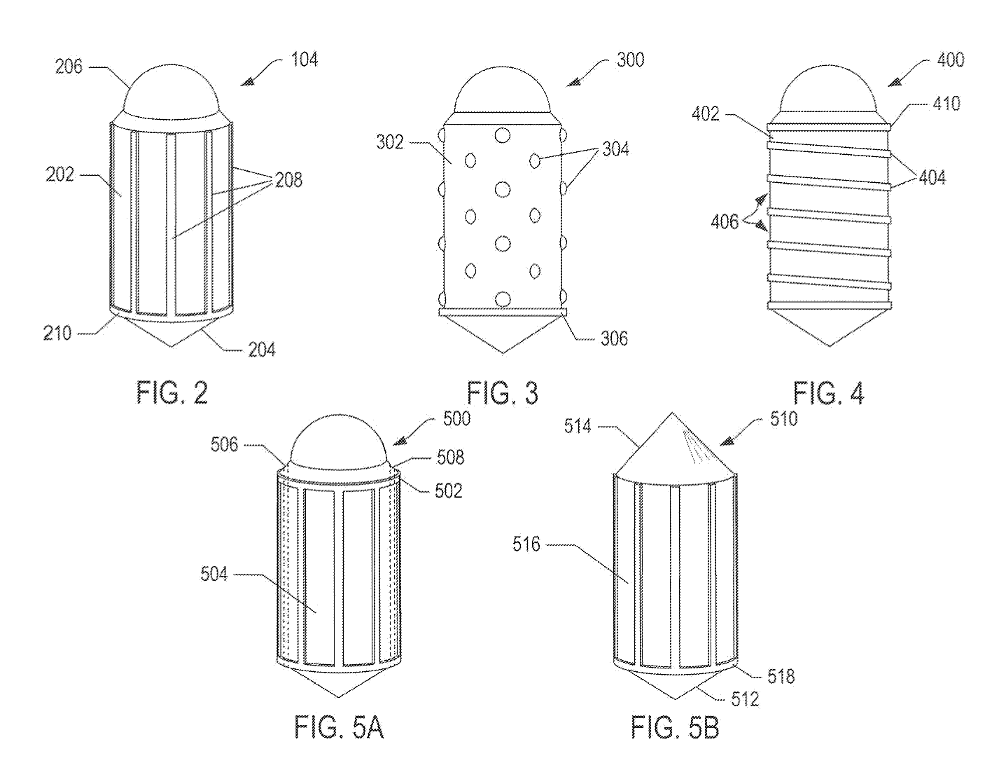

FIG. 2 shows an isometric view of the float 104 shown in FIG. 1. The float 104 includes a main body 202, a cone-shaped tapered end 204, a dome-shaped end 206, splines 208 that are radially spaced and axially oriented on the main body 202, and a single circular rib 210 located along the bottom edge of the main body 202. The splines 208 and rib 210 are configured to provide a sealing engagement with the inner wall of the tube 102. In alternative embodiments, the number of splines, spline spacing, and spline thickness can each be independently varied. The splines 208 can also be broken or segmented. The rib 210 diameter can be approximately equal to, or slightly greater than, the inner diameter of the tube 102, and the main body 202 is sized to have an outer diameter that is less than the inner diameter of the tube 102, thereby defining fluid retention channels between the outer surface of the body 202 and the inner wall of the tube 102. The surfaces of the main body 202 between the splines 208 can be flat, curved or have another suitable geometry. In the example of FIG. 2, the splines 208, the rib 210 and the main body 202 form a single structure.

In other embodiments, the main body of the float 104 can be configured with a variety of different support structures for separating target materials, supporting the tube wall, or directing the suspension fluid around the float during centrifugation. FIGS. 3 and 4 show two examples of different types of main body structural elements that can be included in the main body of a float. Embodiments of the present invention are not intended to be limited to these examples.

In FIG. 3, the main body 302 of a float 300 is similar to the float 104 except the main body 302 includes a number of protrusions 304 that provide support for the deformable tube. In alternative embodiments, the number and pattern of protrusions can be varied. Like the float 104, the float 300 also includes a circular shaped rib 306 located along an edge of the main body 302.

In FIG. 4, the main body 402 of a float exterior 400 includes a single continuous helical structure or ridge 404 that spirals around the main body 402 creating a helical channel 406. In other embodiments, the helical ridge 404 can be rounded or broken or segmented to allow fluid to flow between adjacent turns of the helical ridge 504. The float 400 also includes two circular shaped ribs 408 and 410 located along opposite edges of the main body 402. In various embodiments, the helical ridge spacing and rib thickness can be independently varied.

In alternative embodiments, a float can include a pressure release system to alleviate pressure that builds up in the fluid trapped below the float during centrifugation. The pressure release system prevents the material or particles trapped in the fluid below the float from being forced into an annular gap between the outer surface of the tube and the inner wall of the tube, which contains the target material. This pressure may cause fluid to be forced into the annular gap, thus making detection of the contents of the target material more difficult. Alternatively, the collapse of the side wall of the tube during deceleration may produce excessive or disruptive fluid flow through the annular gap between the main body of the float and the inner wall of the tube 102. The pressure release system can be bore holes that run the axial length of the float and allow for any excessive fluid flow or any resultant pressure in the dense fractions trapped below the float to be relieved. The excess fluid flows into the bore holes, thus preventing degradation of the trapped target material.

FIG. 5B shows an example of a float 500 with a pressure release system. The tube 500 is similar the tube 104, except the float 500 includes a circular rib 502 located along the top edge of the main body 504. The float 500 also includes two bore holes 506 and 508 that extend the length of the main body 504. Note that embodiments of the present invention are not limited to the float containing two bore holes. In other embodiments, the float can include one bore hole or the float can include three or more bore holes, and the bore holes can be located anywhere along the axial length of the float.

Embodiments of the present invention include other types of geometric shapes for float end caps. FIG. 5B shows an isometric view of an example float 510 with two cone-shaped end caps 512 and 514. The main body 516 of the float 510 includes the same structural elements (i.e., splines and rib) as the float 104. The float 510 also includes a circular shaped rib 518 located along an edge of the main body 516.

A float can be composed of a variety of different materials including, but are not limited to, rigid organic or inorganic materials, and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer and others.

### Methods for Isolating Target Materials of a Suspension

For the sake of convenience, methods for isolating a target material in a suspension are described with reference to an example suspension and example target material. In this example, the target materials are CTCs, the non-target materials are white blood cells (“WBCs”), and the suspension is anticoagulated whole blood. Note however that methods of the present invention are not intended to be so limited in their scope of application. The methods described below can, in practice, be used to isolate any kind of target material from a non-target material in nearly any kind of suspension and are not limited to isolating CTCs from WBCs of a whole blood sample.

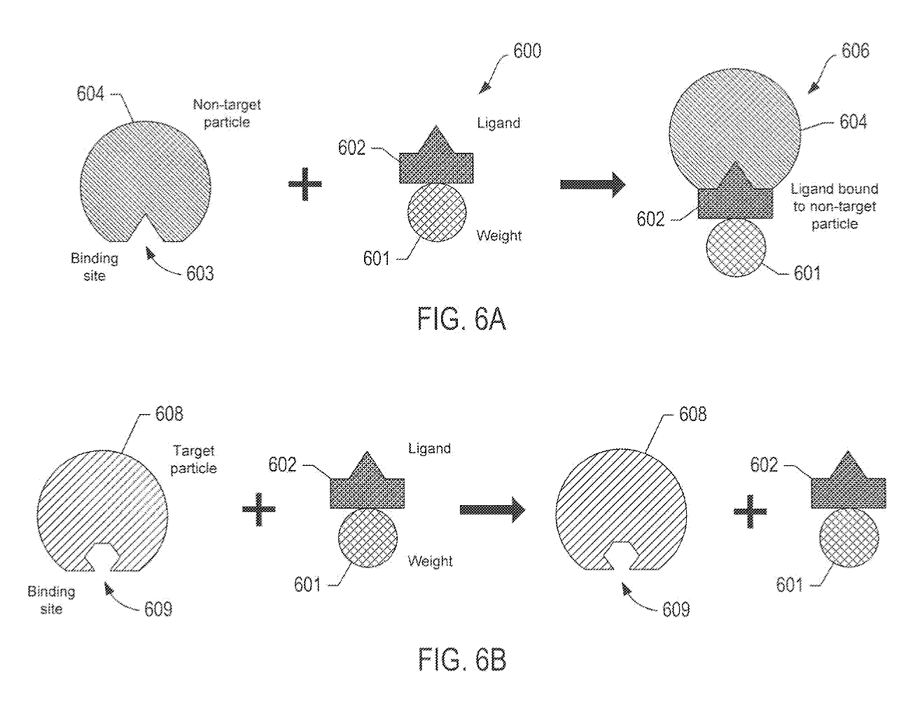

Certain methods for separating a non-target material from a target material include introducing a solution containing ligands with attached weights to the suspension. The ligands are selected to bind specifically to non-target material particles and not to bind to target material particles. A ligand can be a molecule that binds to a particular binding site of a non-target particle. A weight can be a molecule that effectively changes in the specific gravity of the non-target particle. FIG. 6A shows an example reaction of a ligand/weight compound 600 that binds to a non-target particle 604. The compound 600 includes a weight 601 attached to a ligand 602 that binds specifically to a binding site 603 of the non-target particle 604. This reaction results in formation of a non-target particle/ligand/weight complex 606. Alternatively, FIG. 6B shows a target particle 608 with a binding site 609 that does not accept binding with the ligand 602. As a result, the ligand 602 does not bind to the target particle 608. For example, a WBC surface includes specific antigens and these antigens can be used to identify the WBS by the type of antibody that binds to the antigens. For example, CD45, CD66b, and CD33 are antibodies that bind to specific WBC antigens. With reference to FIG. 6A, the non-target particle 604 can represent a WBC, binding site 603 can represent a particular antigen, ligand 602 can represent an antibody that binds specifically to the binding site 603, and target particle 608 can represent a CTC.

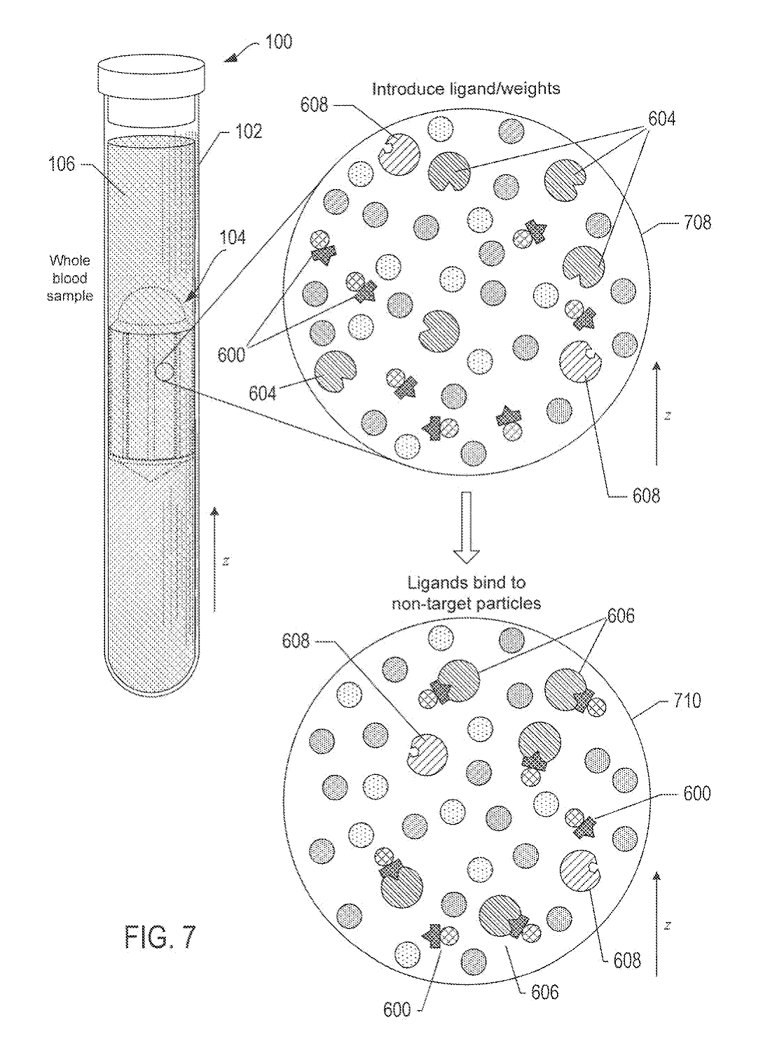

A solution containing the ligand/weight complex is added to the suspension and the ligand/weight complexes are allowed to bind to the non-target particles. FIG. 7 shows a suspension 106 disposed within the tube and float system 100. The float 104 is selected with a specific gravity to substantially match the specific gravity of the target material. FIG. 7 includes a snap-shot 708 of the suspension 106 between the tube and float just after the ligand/weight compound 600 solution has been added to the tube 102. A period of time is allowed to pass in order to allow the ligand/weight complex to bind to the non-target particles. Alternatively, the tube and float system with the suspension and complex solution can be jostled or rocked back and forth for a period of time in order to increase non-target particle 604 interactions with the ligand/weight complexes 600. Snap shot 710 shows the non-target particle/ligand/weight complex 606 formed as a result of allowing the ligand/weight complexes 600 to interact with the non-target particles 604.

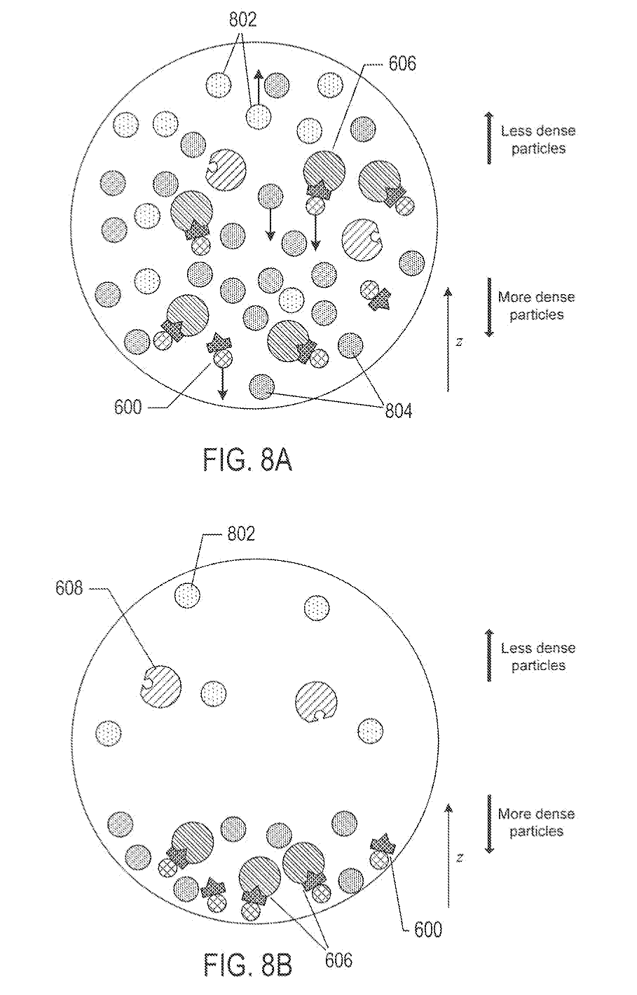

In certain embodiments, the weights can be selected to increase the mass of the complex 606 so that when the tube and float system is centrifuged, the complexes 606 are drawn below the float 104. For example, the weights 601 can be metal-based compounds, metal complexes, or quantum dots. FIG. 8A shows a snap shot of a region between the surface of the float 104 and the inner surface of tube 102 at the beginning of centrifugation. When centrifugation begins less dense particles also present in the suspension 106, represented by light shaded circles 802, are drawn upward while higher density particles, represented by dark shaded circles 804, and the complexes 600 and 606 are drawn downward. FIG. 8B shows a snap shot after a period of time during centrifugation with the low density particles 802 and higher density particles 600, 606, and 804 substantially removed, leaving the target particles 608 between the float 104 and the tube 102.

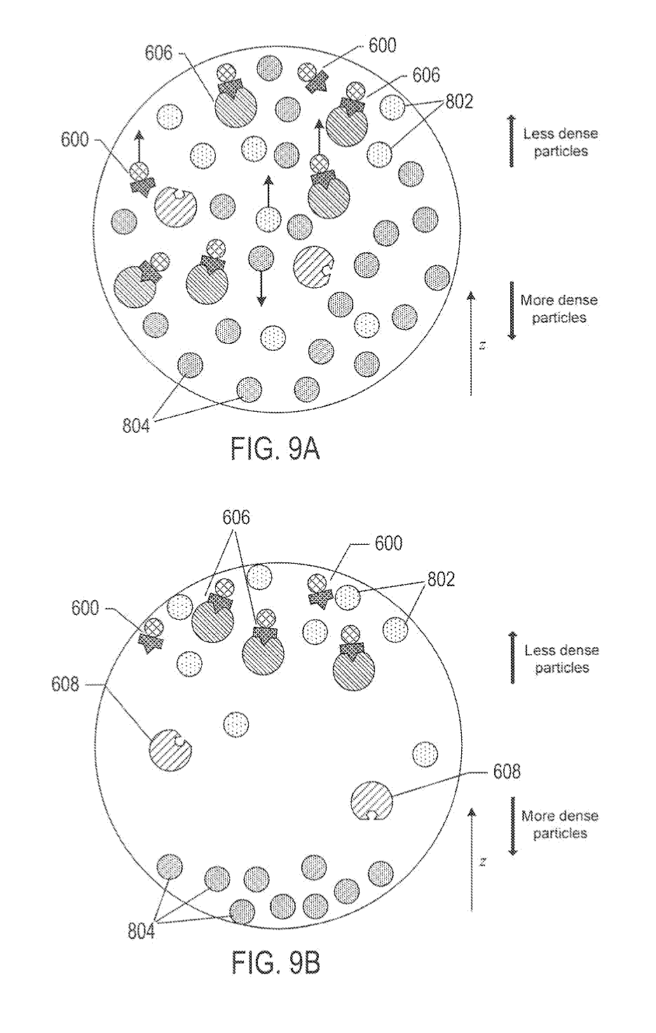

In certain embodiments, the weights can be selected to decrease the density of the complex 606 so that when the tube and float system is centrifuged, the complexes 606 are drawn above the float 104. For example, the weights 601 can be lipids or sugars. FIG. 9A shows a snap shot of a region between the surface of the float 104 and the inner surface of tube 102 at the beginning of centrifugation. When centrifugation begins low density particles 802, 600, and 606 are drawn upward while higher density particles 804 are drawn downward. FIG. 9B shows a snap shot after a period of time during centrifugation with the low density particles 802, 600, and 606 and higher density particles 804 substantially removed, leaving the target particles 608 between the float 104 and the tube 102.

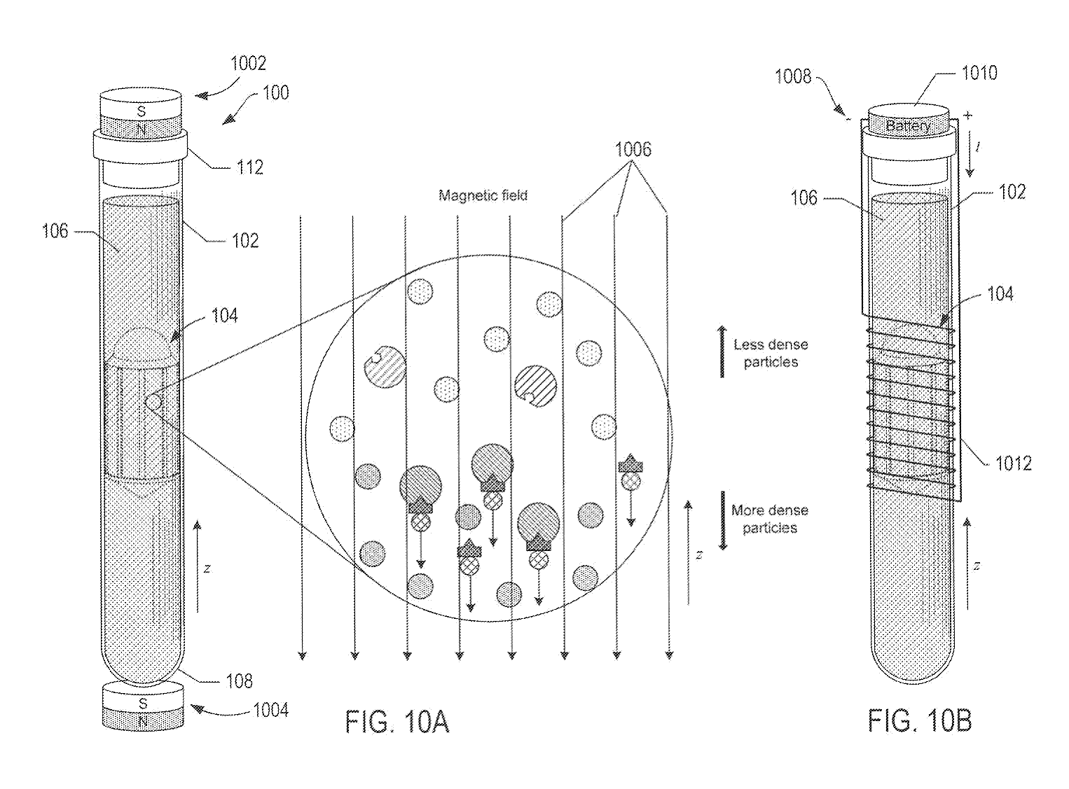

In certain embodiments, the weight 601 can be a magnetically permeable particle and the compound 600 is a magnetically permeable compound. For example, the weight 601 can be a paramagnetic particle, ferromagnetic particle, or an ion that can be used to draw the complex 606 below or above the float 104 in accordance with an applied magnetic field. FIG. 10A shows a first magnet 1002 disposed on the cap 112 and 1004 and a second magnetic disposed near closed end 108. As shown in the example of FIG. 10A, the north and south poles, denoted by “N” and “S,” respectively, of the magnets 1002 and 1004 are oriented to create a magnetic field that runs the length of the tube, as represented by field lines 1006. As shown in FIG. 10A, the magnetic field 1006 draws the complexes 600 and 606 away from the region between the float 104 and the tube 102. FIG. 10B shows an electromagnet system 1008 composed of a battery 1010 disposed on the cap 112 and a coiled wire 1012 connected to the battery 1010. The wire 1012 wraps around the tube 102 in the region where the target material and float 104 are expected to settle during centrifugation. The current I created by the battery 1010 in turn creates a magnetic field, also represented by field lines 1006. Alternatively, the battery 1010 can be disposed within the cap 112.

Note that the magnetic field 1006 can be applied prior to centrifugation or during centrifugation. For example, the tube and float system 100 can be placed between the magnets 1002 and 1004 for a period of time prior to centrifugation, or the magnet 1002 can be attached to the cap 112, or embedded within the cap 112, and the magnet 1004 can be attached to the closed end 108 or placed in the bottom of a centrifuge chamber prior to placement of the tube and float system 100, enabling the system 100 and magnets 1002 and 1004 to be centrifuged together. Alternatively, the electromagnetic system 1008 can be applied for a period of time prior to centrifugation, or the system 100 with the electromagnetic system 1008 attached can be centrifuged together.

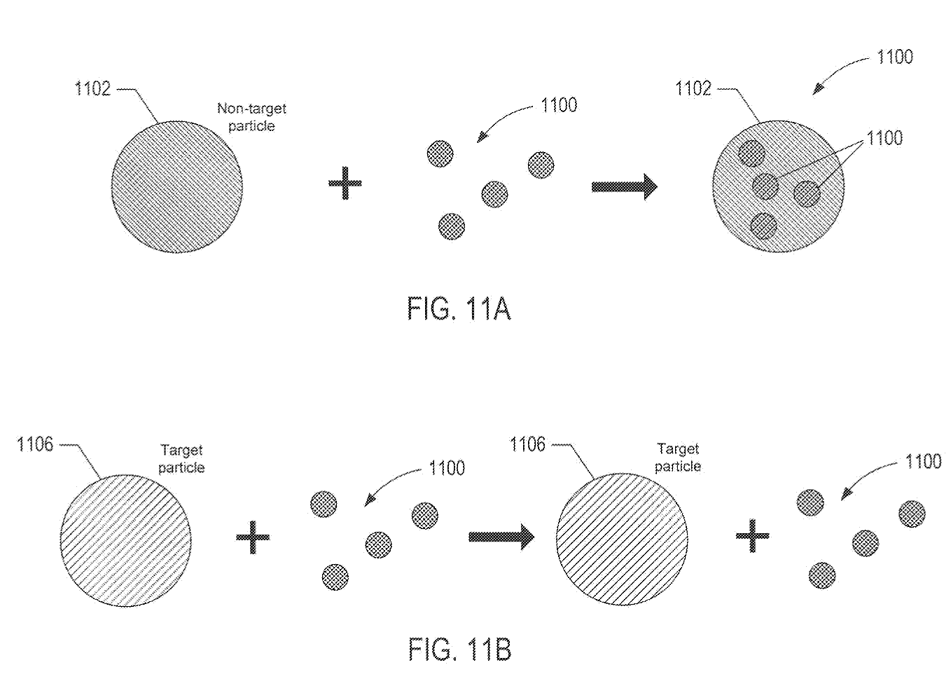

In still other embodiments, the non-target particles can be exposed to a molecule that when absorbed lowers the density of the non-target particles. The molecule is referred to as “buoyant molecule.” FIG. 11A shows an example reaction of buoyant molecules 1100 absorbed by a non-target particle 1102 forming a non-target particle/buoyant molecule complex 1104. Alternatively, FIG. 11B shows a target particle 1106 that does not absorb the buoyant molecules 1100. As a result, the density of the particle/molecule complex 1104 is reduced, but the density of the target particle 1106 remains unchanged.

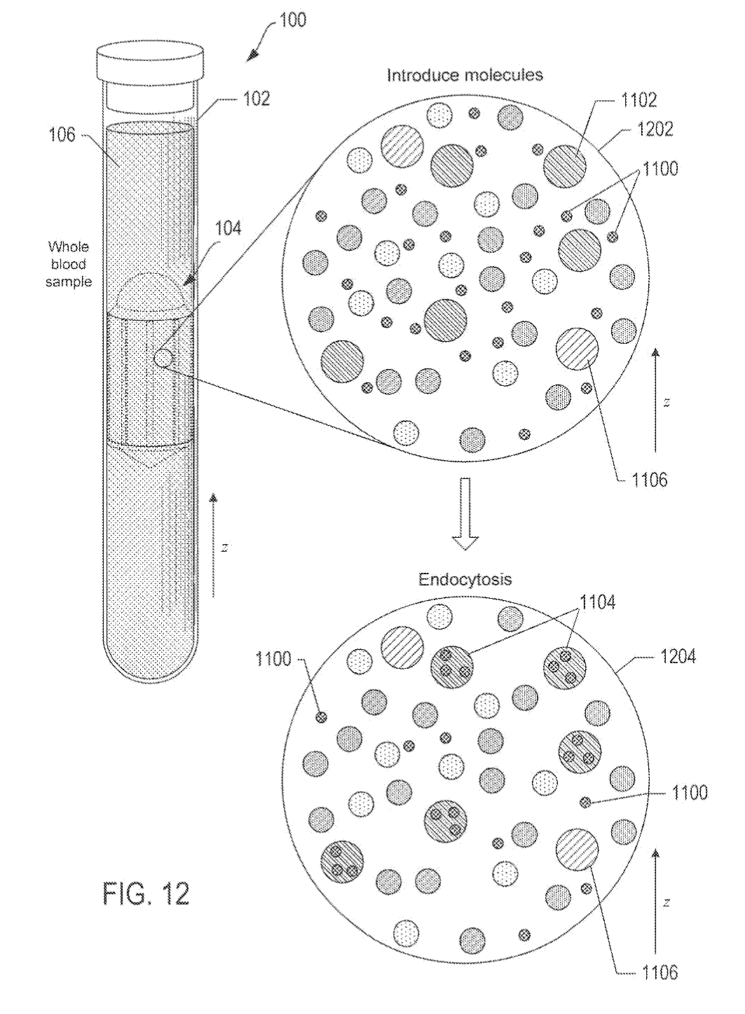

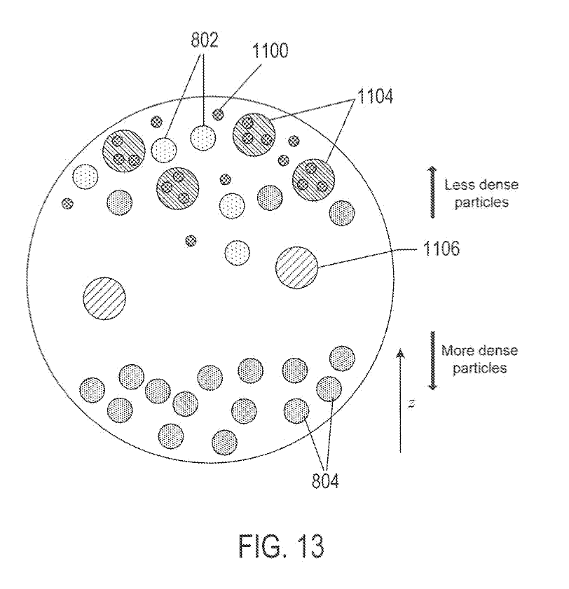

A solution containing the buoyant molecules is added to the suspension and the non-target particles are allowed a period of time to absorb the buoyant molecules. FIG. 12 shows a suspension 106 disposed within the tube and float system 100. The float 104 is selected with a specific gravity to substantially match the specific gravity of the target material. FIG. 12 includes a snap-shot 1202 of the suspension 106 between the tube and float just after the solution containing the buoyant molecules 1100 has been added to the tube 102. A period of time is allowed to pass in order to allow the non-target particles 1102 to absorb the buoyant molecules 1100. Alternatively, the tube and float system 100 is jostled or rocked back and forth for a period of time in order to increase non-target particle 1102 interactions with the buoyant molecules 1100. Snap shot 1204 shows the non-target particle/buoyant molecule complexes 1104 formed as a result of non-target particles absorbing the buoyant molecules 1100.

When centrifugation begins low density particles are drawn upward while higher density particles are drawn downward. FIG. 8B shows a snap shot after a period of time during centrifugation with the low density particles 802, 1100, and 1104 drawn upward and higher density particles 804 drawn downward, leaving the target particles 1106 between the float 104 and the tube 102.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented for purposes of illustration and description. They are not intended to be exhaustive of or to limit this disclosure to the precise forms described. Obviously, many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. A method for isolating target particles from non-target particles of a suspension, the method comprising:
introducing the suspension to a tube and float system, the float having a density that substantially matches the density of the target particles;
introducing a solution that includes a compound that selectively attaches to the non-target particles and does not bind to the target particles;
forming non-target particle/molecule complexes when a target molecule interacts with a non-target particle; and
centrifuging the suspension and the tube and float system to draw the non-target particle/molecule complexes away from an annular region of space between the outer surface of the float and the inner wall of the tube.

2. The method of claim 1, wherein forming the non-target particle/compound complex further comprises rocking the tube and float system.

3. The method of claim 1, wherein the compound further comprises a weight molecule attached to a ligand and the ligand binds to a binding site of the non-target molecule.

4. The method of claim 4, wherein the weight molecule further comprises the non-target particle/compound complex density is greater than the density of the float.

5. The method of claim 4, wherein the weight molecule further comprises the non-target particle/compound complex density is less than the density of the float.

6. The method of claim 4, wherein the weight molecule further comprises a paramagnetic molecule that draws the non-target particle/compound complex away from the float when a magnetic field is applied.

7. The method of claim 4, wherein the weight molecule further comprises a ferromagnetic molecule that draws the non-target particle/compound complex away from the float when a magnetic field is applied.

8. The method of claim 1, wherein the compound that selectively attaches to the non-target particles further comprises the compound is absorbed by the non-target particles.

9. The method of claim 6, wherein the non-target particle/compound complex density is less than the density of the float.

10. A method for isolating target particles from non-target particles of a suspension, the method comprising:
introducing the suspension to a tube and float system, the float having a density that substantially matches the density of the target particles;
introducing a solution that includes a magnetically permeable compound that selectively attaches to the non-target particles and does not bind to the target particles;
applying a magnetic field oriented along the axial length of the tube; and
centrifuging the suspension and the tube and float system to draw non-target particle/molecule complexes away from an annular region of space between the outer surface of the float and the inner wall of the tube.

11. The method of claim 10, wherein further comprising rocking the tube and float system.

12. The method of claim 10, wherein the magnetically permeable compound further comprises a magnetically permeable molecule attached to a ligand and the ligand binds to a binding site of the non-target molecule.

13. The method of claim 12, wherein the magnetically permeable particle further comprises a paramagnetic particle that draws the non-target particle/compound complex away from the float when the magnetic field is applied.

14. The method of claim 12, wherein the magnetically permeable particle further comprises a ferromagnetic particle that draws the non-target particle/compound complex away from the float when the magnetic field is applied.

15. The method of claim 10, wherein applying the magnetic field further comprise applying the magnetic field prior to centrifugation.

16. The method of claim 10, wherein applying the magnetic field further comprise applying the magnetic field during centrifugation.
